(19) United States
(12) Patent Application Publication
(10) Pub. No.: US 2005/0130492 A1
(43) Pub. Date: Jun. 16, 2005

(54) Receptacle having electric power code box installed therein

(75) Inventor: Shi Youl Noh, Kyonggi-do (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: FEELUX Co., Ltd.

(21) Appl. No.: 10/735,013

(22) Filed: Dec. 12, 2003

(51) Int. Cl. H01R 13/72

(52) U.S. Cl. 439/501

(57) ABSTRACT

The present invention relates to a receptacle having an electric power cord box installed therein. An object of the present invention is to provide a receptacle having an electric power cord box installed therein for containing redundant portions of an electric power cord therein with them wound up. The receptacle includes: a casing having an electric power cord box installed therein, and a plurality of cord through-holes formed at one side thereof; and a socket unit having a plurality of branch jacks formed at one side of the interior of the casing and adapted to branch the electric power supplied thereto.

### BACKGROUND OF THE INVENTION

1. Field of the Invention

The present invention relates to a receptacle having an electric power cord box installed therein, and more particularly, to a receptacle having an electric power cord box installed therein, in which the power code box has protrusion rods on which redundant portions of power cords, telephone lines, LAN lines, etc., that are connected to various electric devices are wound up, thereby preventing them from getting twisted or tangled to orderly arrange the surroundings of the receptacle.

2. Background of the Related Art

In general, a receptacle has jacks formed therein for inserting a plug thereto so that the electric power can be supplied to electric devices, etc. A multi-receptacle having a plurality of jacks has recently been used due to the use of various electric devices.

The multi-receptacle is mainly used for electric/electronic devices where lots of the power is needed such as a computer, etc. Since the cords used for the electric devices are different in length, however, they often get twisted or tangled. For this reason, there have been problems in that the surroundings of the electric devices are not well orderly arranged and it is very inconvenient to make their surroundings clean.

Furthermore, the lengths of the telephone lines and the LAN lines are different from each other, causing the surrounding environment to be complicated.

### SUMMARY OF THE INVENTION

Accordingly, the present invention has been made in view of the above problem, and an object of the present invention is to provide a receptacle having an electric power cord box installed therein for containing redundant portions of an electric power cord therein with them wound up.

To achieve the above objects, according to the present invention, there is provided a receptacle including: a casing having an electric power cord box installed therein, and a plurality of cord through-holes formed at one side thereof; and a socket unit having a plurality of branch jacks formed at one side of the interior of the casing 10 and adapted to branch the electric power supplied thereto.

Preferably, the receptacle further includes winding means formed within the power cord box, for winding up redundant portions of power cords connected to plugs that are connected to the branch jacks.

Also, preferably, the socket unit further includes a power supply jack for supplying the electric power to the receptacle.

In addition, the socket unit further preferably includes a telephone jack and a LAN jack for connecting a telephone line and a LAN line thereto, respectively.

The winding means preferably includes a pair of protrusion rods on which the power cords are wound up in such a manner that they are extended between the protrusion rods.

Also, preferably, the receptacle further includes a cover hingeably coupled to the casing.

Further, preferably, each of the cord through-hole has a U shape.

In addition, the power supply jack and the branch jacks are formed at one side of the interior of the casing in such a manner as to be oriented toward the power cord box.

The socket unit further preferably includes a switch formed in each of the branch jacks and the power supply jack thereof.

Also, preferably, the switch further includes an indicator lamp formed at one side thereof.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view illustrating a receptacle according to a preferred embodiment of the present invention,

FIG. 2 is a plan view of the receptacle shown in FIG. 1,

FIG. 3 is a cross-sectional view of the receptacle shown in FIG. 1, and

FIG. 4 shows the receptacle to which the power supply line is integrally coupled according to the preferred embodiment of the present invention.

### DETAILED DESCRIPTION OF THE PREFERRED EMBODIMENT

Reference will now be made in detail to the preferred embodiments of the present invention, examples of which are illustrated in the accompanying drawings.

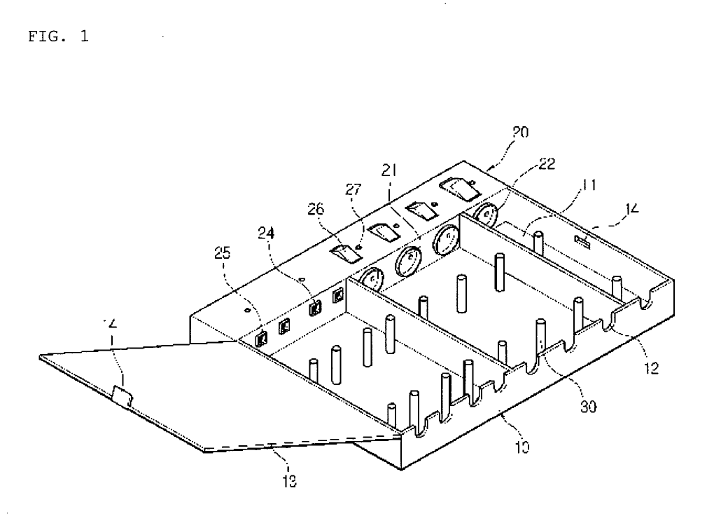

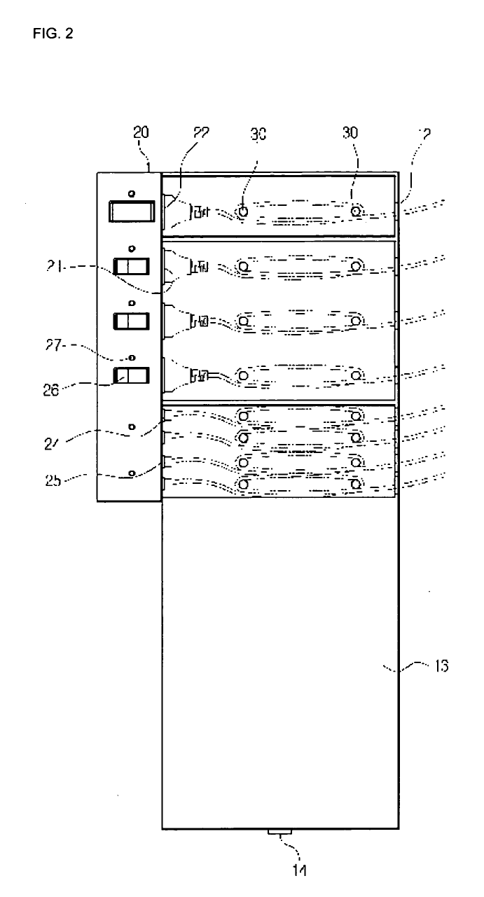

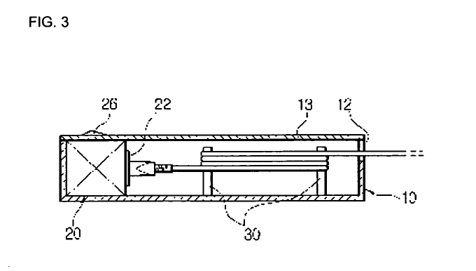

A receptacle according to a preferred embodiment of the present invention will now be described in detail hereinafter with reference to FIGS. 1 to 4.

As shown in the drawings, the receptacle includes a casing 10, a socket unit 20 and winding means, as essential elements.

The casing 10 has a quadrangular shape and has an electric power cord box 11 installed therein. Further, the casing 10 has cord through-holes 12 at its one side. At this time, it is preferred that each of the cord through-holes 12 has a U shape.

The socket unit 20 has a plurality of branch jacks 21 formed at one side of the interior of the casing 10, for branching the electric power supplied thereto.

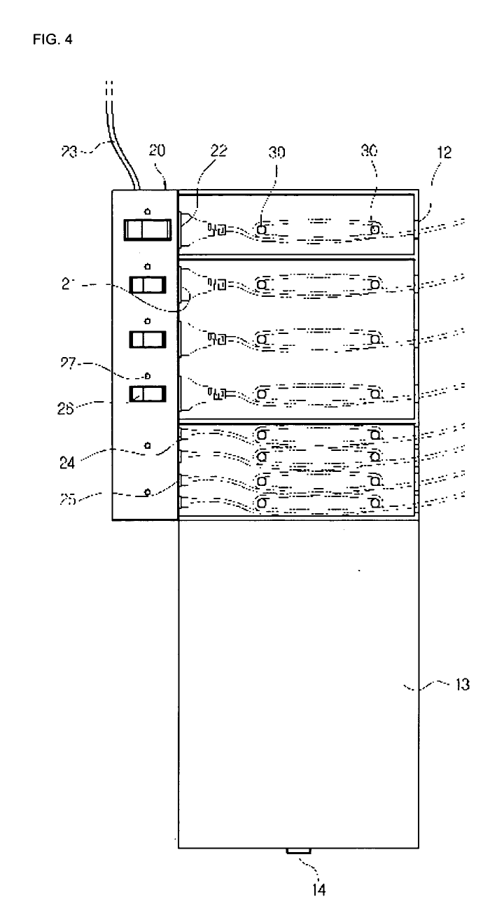

In the above configuration, a power supply jack 22 for supplying the power may be formed in the socket unit 20. As shown in FIG. 4, a power supply line 23 may be directly integrally coupled to the socket unit 20.

It is preferable that the power supply jack 22 and the ramification jacks 21 are formed at one side of the interior of the casing 10 in such a manner as to be oriented toward the power cord box 11.

The winding means may be further formed within the power cord box 11.

Thus, unnecessary power cords may be received within the code box 11.

The winding means is configured such that redundant portions of the power cords connected to a plug are wound up thereon, and includes a pair of protrusion rods on which the power cords are wound up in such a manner that the power cords are extended between the protrusion rods.

A telephone jack 24 and a LAN jack 25 which are connected to a telephone line and a LAN line may be further formed in the socket unit 20.

It is preferable that each of the telephone jack 24 and the LAN jack 25 includes a jack introduced from the outside and a jack connected to the electric device.

At this time, both the telephone line jack 24 and the LAN line jack 25 are oriented toward the power cord box 11 like the branch jacks 21.

Furthermore, a cover 13 is hingeably coupled to one side of the power cord box 13. The cover 13 has a press-fitting protrusion 15 formed at one end thereof so that the press-fitting protrusion 15 is snap-fitted into a press-fitting hole 15 formed in a sidewall of the casing 10.

Switches 26 for connecting/disconnecting electric power source of the power supply jack 22 and the branch jacks 21 are formed in the socket unit 20. A display lamp 27 is formed at one side of each of the switches 26.

The action of the receptacle according to the present invention will now be described hereinafter.

The power supply line 23 that is leaded from an electric outlet (not shown) installed at the wall of a house is connected to the receptacle having the power cord box 11 of the present invention.

At this time, the power supply line 23 may be connected to the power supply jack 22 via a plug or directly connected to the receptacle without the power supply jack 22.

The electric power source is connected/disconnected by the switches 26. Further, whether the power is supplied or not is displayed on the indicator lamp 27.

Furthermore, power cords connected to respective electric devices pass through the cord through-holes 12 formed at one side of the cord box 11. Redundant portions of the power cords are then wound around the pair of the protrusion rods 30, which are spaced apart from each other by a certain distance within the code box 11. Next, the plugs connected to the ends of the power cords are inserted into the branch jacks 21 for electrical connection.

The telephone line and the LAN line are also wound around the protrusion rods 30 through the cord through-holes 12 so that redundant portions of the lines can be simply orderly arranged.

As described above, according to a receptacle according to the present invention, redundant portions of a power cord and/or line are wound up around a pair of protrusion rods formed within a power cord box, thereby preventing them from getting twisted or tangled to orderly arrange the surroundings of the receptacle in a simple manner.

Further, in case of a telephone line or a LAN line, redundant portions of the line are wound up around the pair of the protrusion rods so that the surroundings of the receptacle can be orderly arranged.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A receptacle, comprising:
a casing having an electric power cord box installed therein, and a plurality of cord through-holes formed at one side thereof; and
a socket unit having a plurality of branch jacks formed at one side of the interior of the casing and adapted to branch the electric power supplied thereto.

2. The receptacle as claimed in claim 1, further comprising
winding means formed within the power cord box, for winding up redundant portions of power cords connected to plugs that are connected to the branch jacks.

3. The receptacle as claimed in claim 1, wherein the socket unit further includes a power supply jack for supplying the electric power to the receptacle.

4. The receptacle as claimed in claim 1, wherein the socket unit further preferably includes a telephone jack and a LAN jack for connecting a telephone line and a LAN line thereto, respectively.

5. The receptacle as claimed in claim 2, wherein the winding means includes a pair of protrusion rods on which the power cords are wound up in such a manner that they are extended between the protrusion rods.

6. The receptacle as claimed in claim 1, further comprising a cover hingeably coupled to the casing.

7. The receptacle as claimed in claim 1, wherein the cord through-hole has a U shape.

8. The receptacle as claimed in claim 1, wherein the branch jacks are oriented toward the power cord box.

9. The receptacle as claimed in claim 3, wherein the power supply jack is oriented toward the power cord box.

10. The receptacle as claimed in claim 4, wherein the telephone jack and the LAN jack are oriented toward the power cord box.

11. The receptacle as claimed in claim 1, wherein the socket unit further comprises a switch formed in each of the branch jacks thereof.

12. The receptacle as claimed in claim 3, wherein the socket unit further comprises a switch formed in the power supply jack thereof.

13. The receptacle as claimed in claim 11, wherein the switch further includes an indicator lamp formed at one side thereof.

14. The receptacle as claimed in claim 12, wherein the switch further includes an indicator lamp formed at one side thereof.
